(19) United States
(12) Patent Application Publication
(10) Pub. No.: US 2013/0113945 A1
(43) Pub. Date: May 9, 2013

(54) HANDLE

(71) Applicant: Udo Tockweiler, Immendingen (DE)

(72) Inventor: Udo Tockweiler, Immendingen (DE)

(21) Appl. No.: 13/669,398

(22) Filed: Nov. 5, 2012

(30) Foreign Application Priority Data
Nov. 4, 2011 (DE) 102011117700.4

(51) Int. Cl. G06F 3/00

(52) U.S. Cl. CPC G06F 3/005
USPC 348/207.1

(57) ABSTRACT

A handle for a surgical light includes a housing that is not completely electromagnetically shielded. An HD camera, an image processing device, a compression device, a radio transmission device, and at least one antenna capable of transmitting a compressed HD video signal are disposed within the housing.

### BACKGROUND OF THE INVENTION

1. Field of the Invention

The presently claimed invention relates to a handle for a surgical light. More particularly, the presently claimed invention relates to a handle for a surgical light that includes a housing that is at least partially unshielded against electromagnetic radiation, a high-definition (HD) camera, and at least one antenna capable of transmitting a compressed HD video signal.

2. The Prior Art

Handles for surgical lights are generally known in the prior art. Known handles use plugs to transmit the image signal of the HD camera to the surgical light. A compression device then compresses the image signal in real time and transmits it to an external decompression device through a transmission line.

Surgical lights are generally suspended at the end of a rod. The rod has joints that allow it to rotate 360 degrees. Accordingly, it is necessary to replace the transmission line at the joints with 360 degree rotary plugs and 360 degree sliding contacts. This allows the light to pivot without damaging the transmission line. However, designs featuring 360 degree rotary plugs and 360 degree sliding contacts have to satisfy difficult demands with regard to electromagnetic shielding requirements or transmittable data rates. The transmission of the HD video signal to the decompression device in known handles is overly complex and problematic.

### BRIEF DESCRIPTION OF THE INVENTION

According to the presently claimed invention, a handle for a surgical light includes a housing that is at least partially unshielded against electromagnetic radiation. An HD camera, an image processing device, a compression device, a radio transmission device, and at least one antenna capable of transmitting a compressed HD video signal are also disposed within the housing.

According to one aspect of the presently claimed invention, the handle includes a gripping section and a fastening section. The gripping section is disposed below the fastening section and is substantially covered by a grip sleeve. According to another aspect of the presently claimed invention, the housing includes a camera housing and an unshielded upper housing disposed above the camera housing. The grip sleeve is conformably coupled to the camera housing. The grip sleeve may be removed and individually sterilized. The grip sleeve re-conforms to its mechanically correct position as the camera housing is pushed into the grip sleeve. An HD camera is disposed within the camera housing. The HD camera is attached to the camera housing by a camera holder. The HD camera has a viewing opening. The viewing direction may be downward. A clear-glass pane is disposed below the viewing opening. The grip sleeve includes a viewing window that is aligned with the viewing opening of the HD camera and the clear-glass pane. Accordingly, a downward view for the HD camera is enabled through the viewing opening, the clear-glass pane, and the viewing window.

According to another aspect of the presently claimed invention, the gripping section is rotatably coupled to the fastening section by a ball bearing that is disposed at an upper end of the gripping section. An inner ring of the ball bearing is attached to a drive unit. The camera housing is attached to the drive unit by a camera optics mount. The drive unit includes a geared motor that can rotate the gripping section about a vertical center axis with respect to the fastening section. The gripping section may be rotated manually by the surgeon or it may be automatically controlled by an external device. The size of the field illuminated by the surgical light is determined by the degree to which the gripping section is manually rotated. Other camera control parameters may also be controlled, such as white balance, zoom, or the rotation of the HD camera. The rotary movement is converted into control signals by a rotary encoder. Additionally, the HD camera may be rotated independently of the illuminated field setting by the geared motor. The control commands for the geared motor are received through a radio channel.

According to another aspect of the presently claimed invention, an outer ring of the ball bearing is connected by a reinforcement ring to a unshielded upper housing. The unshielded upper housing may be plastic. The unshielded upper housing includes a releasable fastening mechanism that is configured to releasably fasten the handle to the surgical light. The releasable fastening mechanism may be knurled screws that are accessible by removing the grip sleeve. The releasable fastening mechanism also fastens an upper circuit board.

According to another aspect of the presently claimed invention, the upper circuit board includes various electronic components, including a DC-DC converter capable of supplying power to the handle. A bunch pin plug and a sub-D plug are disposed on the upper circuit board. The bunch pin plug is oriented such that it projects upwards out of the upper housing. Because the bunch pin plug projects upwards out of the upper housing, it establishes a ground connection. The bunch pin plug and the sub-D plug transmit the operating current for the handle. In yet another exemplary embodiment, the bunch pin and the sub-D plug control signals to the surgical light that are received through the radio channel. The handle mates with the surgical light when the bunch pin plug and the sub-D plug are oriented correctly.

According to yet another aspect of the presently claimed invention, a lower circuit board is disposed parallel to the upper circuit board and is fastened to the upper circuit board by stud bolts. In yet another exemplary embodiment, the layered, and in particular multilayered, circuit boards are also operatively connected by plug connectors. Electronic components comprising an image processing device, a compression device, and a radio transmission device are also disposed on the lower circuit board.

The layered configuration of the circuit boards allows for the quick and inexpensive exchange of individual circuit boards or even individual components (e.g., to service or upgrade them). The use of multilayer circuit boards also helps with electromagnetic containment. The housing is at least partially unshielded against electromagnetic radiation. This allows for the transmission of signals through at least one antenna. Because the housing is not completely shielded, however, unwanted electromagnetic radiation must be suppressed within the circuit boards themselves. The layered circuit board configuration, along with the use of multilayer circuit boards that have individual layers for shielding electromagnetic radiation, satisfies such suppression requirements.

According to another aspect of the presently claimed invention, the radio transmission device may be a WLAN transceiver capable of transmitting the HD video signals to the external decompression device at 5 GHz in the WLAN-N standard. The radio transmission device may also have different video and audio outputs for the HD video signal, such as high definition serial digital interface (HD-SDi), digital visual interface (DVI-D), or HD multimedia interface (HDMI).

According to another aspect of the presently claimed invention, at least one antenna is disposed within the housing. The antenna is disposed adjacent to the radio transmission device. The antenna transmits radio signals to an external control unit. The radio signals include both video signals and signals for controlling the surgical light and the handle. The antenna is disposed beneath the lower circuit board in the fastening section of the handle. The antenna is disposed in close proximity to the circuit boards so that they do not require long supply lines that are unfavorable for transmitting radio signals. The antenna may operate at either 2.4 GHz or 5 GHz.

According to another aspect of the presently claimed invention, the circuit boards are connected to the HD camera through connection lines. The connection lines are centrally disposed in the handle. As the gripping section is rotated, the connection lines slightly twist but are not exposed to any tensile load. The connection lines may include data transmission lines or power supply lines. An adapter board is disposed on the HD camera that connects the HD camera to the connection lines through adapter plugs. As such, the HD camera can thus easily be replaced by unplugging the adapter plugs.

The video signal generated by the HD camera is compressed by the image processing device and transmitted to the external control unit by the radio transmission device and the antenna. The compression may occur in real time. The external control unit transmits signals to the radio transmission device disposed in the handle. The signals may control the setting of the HD camera or the settings of the surgical light after being amplified on the upper circuit board and transmitted by the sub-D plug.

According to another aspect of the presently claimed invention, the image processing device includes a computer that has a processor, a random access memory (RAM) memory, and a non-volatile memory. The processor may be an ARM 9 microprocessor. The computer includes an autonomous operating system such as Linux. The waste heat of the processor is transmitted to a thermally conductive element through a thermally conductive pad that is bonded to the processor. The bonds are achieved by using a suitable thermally conductive adhesive. The thermally conductive element extends substantially in a plane parallel to the circuit boards. The thermally conductive element outputs the heat supplied to it substantially through the reinforcement ring, the ball bearing, the drive unit, and the camera optics mount. The heat arising at the processor is led off to the environment through the camera housing. Accordingly, the large surface of the camera housing is used as a heat sink. The thermally conductive element may be fastened by screws to the ball bearing and to the drive unit.

### BRIEF DESCRIPTION OF THE DRAWINGS

FIG. 1 is a cross-sectional view of a handle according to an exemplary embodiment of the presently claimed invention.

FIG. 2 is a perspective view of a handle according to an exemplary embodiment of the presently claimed invention with a single cross-section through the housing.

### DETAILED DESCRIPTION OF THE INVENTION

Persons of ordinary skill in the art will realize that the following description of the presently claimed invention is illustrative only and is not in any way limiting. Other embodiments of the invention will readily suggest themselves to such skilled persons.

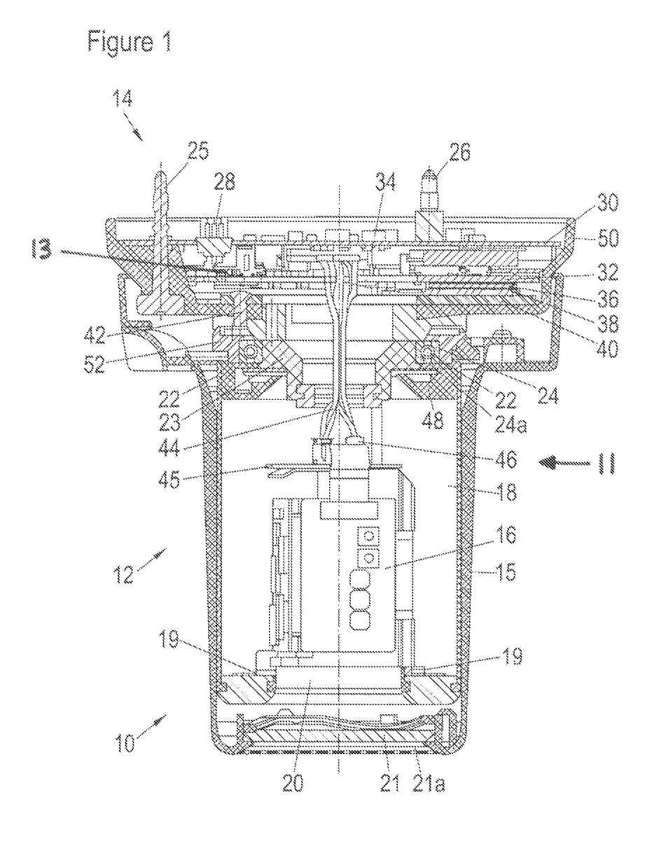

Referring first to FIG. 1, in one exemplary embodiment a handle 10 for a surgical light (not shown) includes a housing 11 that is at least partially unshielded against electromagnetic radiation, an HD camera 18 disposed within the housing 11, and at least one antenna 46 capable of transmitting a compressed HD video signal disposed within the housing 11. In an exemplary embodiment, more than one antenna 46 may be utilized. As discussed further below, the handle 10 also includes a plurality of electronic components 13 disposed within the housing 11 that include an image processing device, a compression device, and a radio transmission device. In another exemplary embodiment, the housing 11 comprises a camera housing 18 and a unshielded upper housing 50.

In another exemplary embodiment, the handle 10 comprises a gripping section 12 and a fastening section 14. The gripping section 12 is disposed below the fastening section 14 and is substantially covered by a grip sleeve 15. The camera housing 18 is disposed within the gripping section 12. The grip sleeve 15 is conformably coupled to the camera housing 18. The grip sleeve 15 may be removed and individually sterilized. The grip sleeve 15 re-conforms to its mechanically correct position as the camera housing 18 is pushed into the grip sleeve 15. An HD camera 16 is disposed within the camera housing 18. The HD camera 16 is attached to the camera housing 18 by a camera holder 19. The HD camera 16 has a viewing opening 20. In one exemplary embodiment, the viewing direction may be downward through the viewing opening 20. A clear-glass pane 21 is disposed below the viewing opening 20. The grip sleeve 15 includes a viewing window 21a that is aligned with the viewing opening 20 of the HD camera 16 and the clear-glass pane 21. Accordingly, a downward view for the HD camera 16 is enabled through the viewing opening 20, the clear-glass pane 21, and the viewing window 21a.

In an exemplary embodiment, the gripping section 12 is rotatably coupled to the fastening section 14 by a ball bearing 22 that is disposed at an upper end of the gripping section 12. An inner ring 24a of the ball bearing 22 is attached to a drive unit 23. The camera housing 18 is attached to the drive unit 23 by a camera optics mount 48. The drive unit 23 includes a geared motor (not shown) that can rotate the gripping section 12 about the shown vertical center axis with respect to the fastening section 14. In one exemplary embodiment, the rotation of the gripping section 12 may be manually controlled by the surgeon. In another exemplary embodiment, the rotation may be automatically, externally controlled. In an illustrative embodiment, the size of the field illuminated by the surgical light is determined by the manual rotation of the gripping section 12. In other illustrative embodiments, other camera control parameters, such as white balance, zoom, or the rotation of the HD camera 16, may also be manipulated by rotating the gripping section 12. The rotary movement is converted into control signals by a rotary encoder (not shown). Additionally, the HD camera 16 may also be rotated independently of the illuminated field setting by the geared motor. In an exemplary embodiment, the control commands for the geared motor are received through a radio channel.

In an exemplary embodiment, an outer ring 24 of the ball bearing 22 is connected by a reinforcement ring 52 to a unshielded upper housing 50. In one exemplary embodiment, the unshielded upper housing 50 may be plastic. In other exemplary embodiments, other non-shielding materials known to persons of ordinary skill in the art may be used. The unshielded upper housing 50 includes a releasable fastening mechanism 25 configured to releasably fasten the handle 10 to the surgical light. In one exemplary embodiment, the releasable fastening mechanism 25 may be knurled screws that are accessible by removing the grip sleeve 15. In another exemplary embodiment, the releasable fastening mechanism 25 is also configured to fasten an upper circuit board 30. Persons of ordinary skill in the art will readily recognize that the many other known releasable fastening mechanisms are suitable.

In an exemplary embodiment, the upper circuit board 30 includes a DC-DC converter 34 capable of supplying power to the handle 10. In other illustrative embodiments, other electronic components may be disposed on the upper circuit board 30, such as those configured for implementing a CAN bus, for amplification, for distribution or A/D conversion of the control signals, or for a USB interface. In one exemplary embodiment, a bunch pin plug 26 and a sub-D plug 28 are disposed on the upper circuit board 30. The bunch pin plug 26 is oriented such that it projects upwards out of the upper housing 50. Because the bunch pin plug 26 projects upwards out of the upper housing 50, it establishes a ground connection. In an exemplary embodiment, the bunch pin plug 26 and the sub-D plug 28 transmit the operating current for the handle 10. In yet another exemplary embodiment, the bunch pin 26 and the sub-D plug 28 control signals to the surgical light that are received through the radio channel. In an illustrative embodiment, the handle 10 mates with the surgical light when the bunch pin plug 26 and the sub-D plug 28 are oriented correctly.

In an exemplary embodiment, a lower circuit board 32 is disposed parallel to the upper circuit board 30 and is fastened to the upper circuit board 30 by stud bolts (not shown). In yet another exemplary embodiment, the layered, and in particular multilayered, circuit boards 30 and 32 are also operatively connected by plug connectors (not shown). As noted above, in an illustrative embodiment, the plurality of electronic components 13 comprising an image processing device, a compression device, and a radio transmission device are disposed on the lower circuit board 32. In an exemplary embodiment, the circuit boards 30 and 32 each have multiple layers upon which all of the relevant conductor tracks are the same length and meandering for reducing the radiation of electromagnetic waves.

In an exemplary embodiment, the radio transmission device may be a WLAN transceiver capable of transmitting the HD video signals to the external decompression device at 5 GHz in the WLAN-N standard. In yet another exemplary embodiment, the radio transmission device may have different video and audio outputs for the HD video signal, such as HD-SDi, DVI-D, or HDMI.

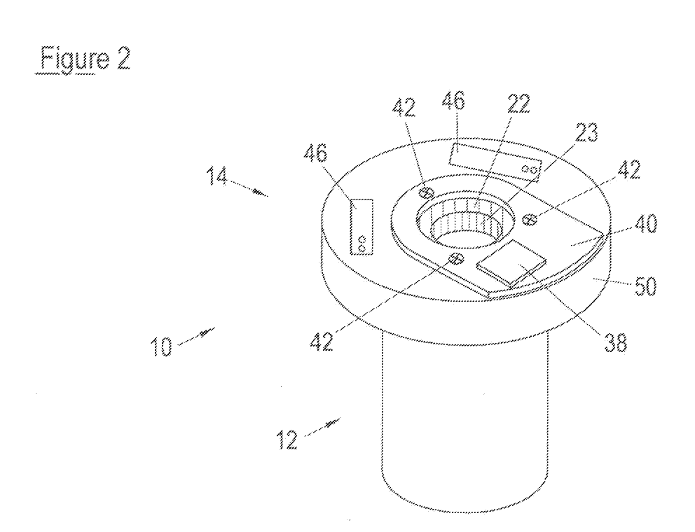

In an exemplary embodiment, at least one antenna 46 (also shown in FIG. 2) is disposed within the housing 11. In yet an exemplary embodiment, the at least one antenna is disposed adjacent to the radio transmission device. The antenna 46 transmit radio signals to an external control unit (not shown). In an exemplary embodiment, the radio signals include both video signals and signals for controlling the surgical light and the handle 10. In another exemplary embodiment, the at least one antenna 46 is disposed beneath the lower circuit board 32 in the fastening section 14 of the handle. In exemplary embodiments, the at least one antenna may operate at either 2.4 GHz or 5 GHz.

In an exemplary embodiment, the image processing device includes a computer that has a processor 36, a RAM memory and a non-volatile memory. In one exemplary embodiment, the processor may be an ARM 9 microprocessor. In yet another exemplary embodiment, the computer includes an autonomous operating system such as Linux.

In an exemplary embodiment, the waste heat of the processor 36 is transmitted to a thermally conductive element 40 through a thermally conductive pad 38 that is bonded to the processor 36. In a further exemplary embodiment, the bonds are achieved by using a suitable thermally conductive adhesive. Persons of ordinary skill in the art will readily recognize many well-known thermally conductive adhesives that are suitable.

In an exemplary embodiment, the thermally conductive element 40 extends substantially in a plane parallel to the circuit boards 30 and 32 (also shown in FIG. 2). The thermally conductive element 40 outputs the heat supplied to it to the camera housing 18 substantially through the reinforcement ring 52, the ball bearing 22, the drive unit 23, and the camera optics mount 48. The heat arising at the processor is led off to the environment through the camera housing 18. The large surface of the camera housing 18 is thus used as a heat sink.

In an illustrative embodiment, the thermally conductive element 40 is fastened by screws 42 to the ball bearing 22 and to the drive unit 23 (also shown in FIG. 2). In another illustrative embodiment, the antenna 46 is disposed beneath the lower circuit board 32 in the fastening section 14 of the handle 10. The antenna 46 is disposed in close proximity to the circuit boards 30 and 32 so that they do not require long supply lines that are unfavorable for transmitting radio signals. In one exemplary embodiment, the antenna 46 is designed for operation at 2.4 GHz. In another exemplary embodiment, the antenna 46 is designed for operation at 5 GHz.

In an exemplary embodiment, the circuit boards 30 and 32 are connected to the HD camera 16 through connection lines 44. The connection lines 44 are centrally disposed in the handle 10. As the gripping section 12 is rotated, the connection lines 44 slightly twist but are not exposed to any tensile load. In one exemplary embodiment, the connection lines 44 include data transmission lines. In yet another exemplary embodiment, the connection lines 44 also include power supply lines. An adapter board 45 is disposed on the HD camera 16 that connects the HD camera 16 to the connection lines 44 through adapter plugs 46. The HD camera 16 can thus easily be replaced by unplugging the adapter plugs 46.

In an exemplary embodiment, the video signal generated by the HD camera 16 is compressed by the image processing device and transmitted to the external control unit by the radio transmission device and the antenna 46. In an exemplary embodiment, the compression occurs in real time. The external control unit transmits signals to the radio transmission device disposed in the handle 10. In one exemplary embodiment, the signals control the setting of the HD camera 16. In another exemplary embodiment, the signals control the settings of the surgical light after being amplified on the upper circuit board 30 and transmitted by the sub-D plug 28.

While embodiments and applications of this invention have been shown and described, it would be apparent to those skilled in the art that many more modifications than mentioned above are possible without departing from the inventive concepts discussed herein. The invention, therefore, is not to be restricted except in the spirit of the appended claims.

What is claimed is:

1. A handle for a surgical light, comprising:
a housing, the housing being at least partially unshielded against electromagnetic radiation;
an HD camera disposed within the housing;
an image processing device disposed within the housing;
a compression device disposed within the housing;
a radio transmission device disposed within the housing; and
at least one antenna capable of transmitting a compressed HD video signal disposed within the housing.

2. The handle of claim 1, further comprising a gripping section and a fastening section.

3. The handle of claim 1, wherein the housing comprises:
a camera housing; and
an upper housing disposed above the camera housing.

4. The handle of claim 1, wherein the radio transmission device is also capable of transmitting signals for controlling the surgical light.

5. The handle of claim 1, further comprising a releasable fastening mechanism configured to releasably fasten the handle to a surgical light.

6. The handle of claim 1, further comprising a plug-in connection configured to connect to a power supply.

7. The handle of claim 1, wherein the image processing device includes a computer, the computer having a processor, a RAM memory, a non-volatile memory, and an autonomous operating system.

8. The handle of claim 7, wherein the autonomous operating system is Linux.

9. The handle of claim 2, wherein the gripping section is rotatably coupled to the fastening section.

10. The handle of claim 2, wherein the HD camera is disposed within the gripping section.

11. The handle of claim 2, wherein the image processing device, the compression device, and the radio transmission device are disposed within the fastening section.

12. The handle of claim 1, further comprising a plurality of electronic components disposed on a plurality of layered circuit boards, the electronic components operatively connected to the image processing device, the compression device, and the radio transmission device.

13. The handle of claim 12, wherein the layered circuit boards are disposed within the fastening section.

14. The handle of claim 12, wherein the layered circuit boards are multilayer circuit boards.

15. The handle of claim 12, wherein the number of layered circuit boards is two.

16. The handle of claim 12, further comprising a DC-DC converter disposed on an upper board of the layered circuit boards.

17. The handle of claim 12, further comprising a processor, a RAM memory, and a compression device disposed on a lower board of the layered circuit boards.

18. The handle of claim 3, wherein the camera housing that is capable of serving as a heat sink.

19. The handle of claim 3, further comprising a thermally conductive element, the thermally conductive element being operatively connected to the camera housing.

20. The handle of claim 3, further comprising:
a thermally conductive element; and
a processor, the processor being operatively connected to the camera housing by the thermally conductive element.
